(19) United States
(12) Patent Application Publication
(10) Pub. No.: US 2013/0220060 A1
(43) Pub. Date: Aug. 29, 2013

(54) OPERATION SENSATION IMPARTING INPUT DEVICE

(71) Applicant: Alps Electric Co., Ltd., (US)

(72) Inventors: Tadashi Sano, Tokyo (JP); Kazuhiko Ito, Tokyo (JP)

(73) Assignee: Alps Electric Co., Ltd., Tokyo (JP)

(21) Appl. No.: 13/744,032

(22) Filed: Jan. 17, 2013

(30) Foreign Application Priority Data
Feb. 24, 2012 (JP) 2012-038806

(51) Int. Cl. G05G 5/00

(52) U.S. Cl. CPC G05G 5/00
USPC 74/504

(57) ABSTRACT

A first rotating body, which is rotated integrally with an operating knob, holds driving bodies and compression coil springs in recesses, and makes the driving bodies come into elastic contact with cam surfaces formed on the inner peripheral surface of a second rotating body. When current is not applied to an electromagnetic brake, the first and second rotating bodies are rotated integrally. When a user further rotates the operating knob against a sensation of resistance while the electromagnetic brake magnetically attracts a friction plate and a braking force is applied, the first rotating body is rotated relative to the second rotating body while the driving bodies slide on the cam surfaces. This relative rotation is allowed until stopper portions provided near the recesses come into contact with restricting wall portions provided near the cam surfaces.

### CLAIM OF PRIORITY

This application claims benefit of Japanese Patent Application No. 2012-038806 filed on Feb. 24, 2012, which is hereby incorporated by reference in its entirety.

### BACKGROUND

1. Field of the Disclosure

The present disclosure relates to an operation sensation imparting input device that can feed an operation sensation back to an operating knob to be rotated by a user, and more particularly, to an operation sensation imparting input device that gives a sensation of resistance preventing the rotation to a user by a braking force of an electromagnetic brake when the user further rotates an operating knob beyond a rotating operation range.

2. Description of the Related Art

This kind of operation sensation imparting input device is used as an input device for in-vehicle instruments, such as a car navigation system or a car audio system, a car air conditioner, and the like. That is, if a user can perceive whether the rotational position of an operating knob is suitably an operation sensation even without visually checking whether the rotational position of an operating knob is proper when driving an automobile, the user can perform an input operation while keeping own eye on the front side. Accordingly, safety during driving is improved.

Such an operation sensation imparting input device can generate a sensation of resistance, which prevents the rotation of the operating knob by controlling the electromagnetic brake, when a user rotates the operating knob beyond the rotating operation range. However, if the operating knob is locked by the electromagnetic brake so that the operating knob cannot be rotated, the user cannot rotate the operating knob even in a reverse direction. That is, when a sensation of resistance preventing rotation (a sensation similar to a sensation when fingers bump against a wall) is given to the fingers of the user that has rotated the operating knob up to the start point or the end point of the rotating operation range, the user will try to instantly rotate the operating knob in the reverse direction. Accordingly, the braking of the electromagnetic brake should be released at this time.

For this reason, even though the operating knob is rotated beyond the rotating operation range and a braking force is applied from the electromagnetic brake, the operating knob is usually adapted so as to be capable of being rotated to a predetermined angle that is slightly beyond the rotating operation range, that is, in the range of an allowable rotation angle where the further rotation of the operating knob beyond the rotating operation range is allowed. Further, the operating knob is adapted so that the braking of the electromagnetic brake is released when the operating knob is rotated in the reverse direction in the range of the allowable rotation angle. Meanwhile, since the rotation direction and the rotation angle of the operating knob can be detected by detection means such as a magnetic sensor or an optical sensor, it is easy to control the electromagnetic brake on the basis of the detection signal of the detection means.

In the past, an operation sensation imparting input device, which includes torque transmission means including elastically deformable portions and interposed between an operating knob and an electromagnetic brake and can allow the operating knob to be rotated in the range of an allowable rotation angle against the braking force of the electromagnetic brake by the torque transmission means, has been proposed as an operation sensation imparting input device that allows the reverse rotation of the operating knob while generating a sensation of resistance preventing the rotation of the operating knob as described above (for example, see Japanese Unexamined Patent Application Publication No. 2010-62075).

In the operation sensation imparting input device in the related art disclosed in Japanese Unexamined Patent Application Publication No. 2010-62075, elastically deformable clip-like members (elastically deformable portions) are mounted on a rotor member rotated integrally with the operating knob and an engaging protrusion, which is to be interposed between the clip-like members, protrudes from a friction plate. The friction plate is movable relative to the rotor member in the thrust direction, and the electromagnetic brake to which current has been applied magnetically attracts the friction plate, so that a braking force is applied to the friction plate. That is, when the operating knob is rotated while the braking force is not applied, the rotor member and the friction plate are rotated integrally with the operating knob. However, if a user tries to further rotate the operating knob after current is applied to the electromagnetic brake and the rotation of the friction plate is prevented, the rotor member is allowed to rotate relative to the friction plate in the range of the allowable rotation angle by the elastic deformation of the clip-like members.

Further, in other solving means in the related art, a tongue portion (elastically deformable portion), which is interposed between a pair of cuts and extends from the inside to the outside in the radial direction, is formed on a disc-shaped rotor member that is rotated integrally with an operating knob, an engaging protrusion, which extends substantially perpendicular to the tongue portion, is formed on the end portion of the tongue portion, and engaging portions, which are provided on both sides of the engaging protrusion in the rotation direction, are formed on a friction plate that is to be magnetically attracted to an electromagnetic brake. Since a base end portion of the tongue portion is formed to be narrow, it is possible to elastically deform the tongue portion in the rotation direction of the rotor member by using the pair of cuts. Due to this structure, the rotor member and the friction plate are rotated integrally with the operating knob while a braking force is not applied. However, even when current is applied to the electromagnetic brake and the rotation of the friction plate is prevented, the rotor member can be rotated relative to the friction plate in the range of the allowable rotation angle by the elastic deformation of the tongue portion.

However, since one end portion of each clip-like member is fixed to the rotor member by a screw or the like in the former structure in the related art, it is difficult to accurately regulate the mounting position of a free end of the clip-like member and positional shift is apt to occur at a portion of the clip-like member that catches the engaging protrusion. Further, the positional shift of the clip-like member causes the intensity of a sensation of resistance, which is generated when the operating knob is rotated beyond the rotating operation range, to fluctuate or causes the allowable rotation angle to fluctuate. Accordingly, there is a concern that the operation sensation or the operability of the operating knob may deteriorate.

Furthermore, the tongue portion, which has a complex shape and is connected to the engaging protrusion, should be formed on a part of the rotor member in the latter structure in the related art. This causes manufacturing costs to increase, and there also is a difficulty in the durability of the tongue portion that is elastically deformed so as to be twisted.

### SUMMARY

An operation sensation imparting input device includes an operating knob, a first rotating body, a second rotating body, a friction plate, an electromagnetic brake, and detection means. The operating knob is to be rotated. The first rotating body is driven by the operating knob and is rotated coaxially with the operating knob. The second rotating body is driven by the first rotating body, is rotatable coaxially with first rotating body, and transmits a braking force to the first rotating body. The friction plate is rotated integrally with the second rotating body. The electromagnetic brake applies a braking force by magnetically attracting the friction plate when current is applied to the electromagnetic brake. The detection means detects the rotational position of the operating knob. Cam surfaces are formed on one of the first and second rotating bodies, and driving bodies elastically coming into press contact with the cam surfaces are held by the other thereof. While the rotation of the friction plate is prevented by the magnetic attraction of the electromagnetic brake, the first rotating body is rotatable relative to the second rotating body until the first rotating body comes into contact with the second rotating body so that the position of the first rotating body is restricted. The driving bodies slide on the cam surfaces while increasing contact pressure with the relative rotation.

Since the driving bodies elastically come into press contact with the cam surfaces in the operation sensation imparting input device having this structure, it is possible to integrally rotate the first and second rotating bodies while the friction plate is not magnetically attracted to the electromagnetic brake. When the operating knob is rotated beyond a rotating operation range, it is possible to give a sensation of resistance to a user by applying current to the electromagnetic brake to prevent the rotation of the friction plate. Accordingly, it is possible to provide an operation sensation imparting input device that easily achieves an increase in life and a reduction in cost. Further, the first rotating body is rotatable relative to the second rotating body by only a predetermined angle until the first rotating body comes into contact with the second rotating body so that the position of the first rotating body is restricted. When both the rotating bodies come into contact with each other, the relative rotation is not performed any more. Accordingly, it is possible to accurately set an allowable rotation angle.

### BRIEF DESCRIPTION OF THE DRAWINGS

FIG. 1 is a perspective view of an operation sensation imparting input device according to an embodiment of the invention;

FIG. 2 is an exploded perspective view of the input device;

FIG. 3 is a cross-sectional view of the input device;

FIG. 4 is a plan view showing a state where an operating knob has been removed from the input device;

FIG. 5 is a plan view showing a state where a knob connecting member has been removed from FIGS. 4; and

FIG. 6 is a plan view corresponding to FIG. 5 when the operating knob is rotated up to a limit allowing further rotation beyond a rotating operation range.

### DESCRIPTION OF THE EXEMPLARY EMBODIMENTS

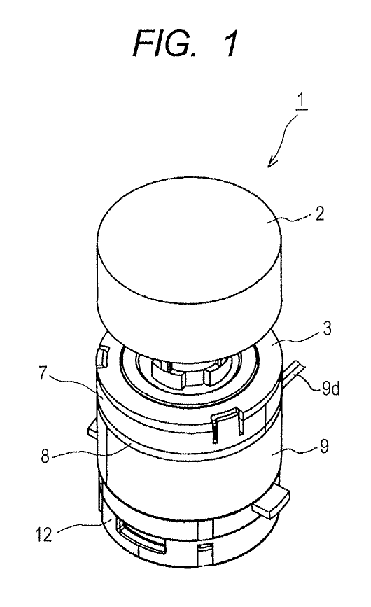

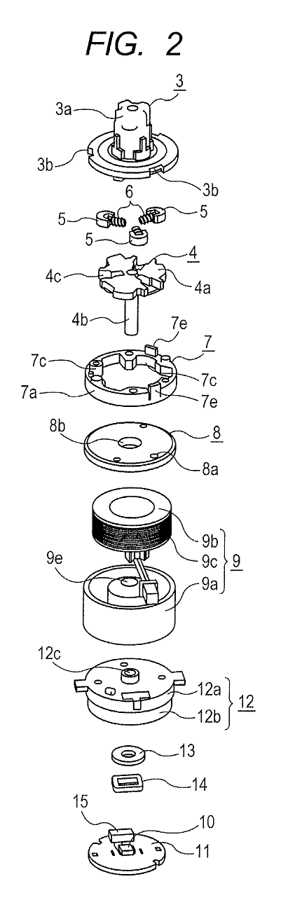

Embodiments of the invention will be described below with reference to FIGS. 1 to 6. An operation sensation imparting input device 1 according to an embodiment of the invention is used as an input device of an in-vehicle instrument such as a car air conditioner, can perform various input operations when a user rotates an operating knob 2, and can make user's fingers perceive a sensation of resistance when a user rotates the operating knob 2 over a rotating operation range.

First, the entire structure of the operation sensation imparting input device 1 will be described. The input device 1 mainly includes an operating knob 2 that is fixed to a knob connecting member 3, a first rotating body 4 that is rotationally driven by the operating knob 2 through the knob connecting member 3, a plurality of driving bodies 5 and compression coil springs 6 that are held by the first rotating body 4, a second rotating body 7 that can be rotated integrally with the first rotating body 4 through the respective driving bodies 5, a friction plate (armature) 8 that is rotated integrally with the second rotating body 7, an electromagnetic brake 9 that applies a braking force by magnetically attracting the friction plate 8 when a current is applied to the electromagnetic brake 9, a circuit substrate 11 on which a magnetic sensor 10 for detecting the rotational position of the operating knob 2 is mounted, and a housing 12 in which detection means including the magnetic sensor 10, a circuit substrate 11, and the like are received.

The operating knob 2 is mounted on a mounting shaft portion 3a of the knob connecting member 3. Protrusions 3c that are fitted to holes 4e of the first rotating body 4 to be described below and a protrusion 3d that is fitted to a hole 4f of the first rotating body 4 to be described below are formed on the mounting shaft portion 3a so as to protrude downward in the drawings. Meanwhile, the operating knob 2, the mounting shaft portion 3a, and the protrusion 3d are formed coaxially. Accordingly, when a user rotates the operating knob 2, the knob connecting member 3, which is rotated integrally with the operating knob 2 while interlocking with the rotation of the operating knob 2, rotates the first rotating body 4 coaxially with the operating knob 2. Notches 3b are formed at three portions that are positioned on the outer peripheral portion of the knob connecting member 3 at regular intervals, and engaging pieces 7e, which will be described below, of the second rotating body 7 are caught by the respective notches 3b. Meanwhile, each of the operating knob 2 and the knob connecting member 3 is a resin molding.

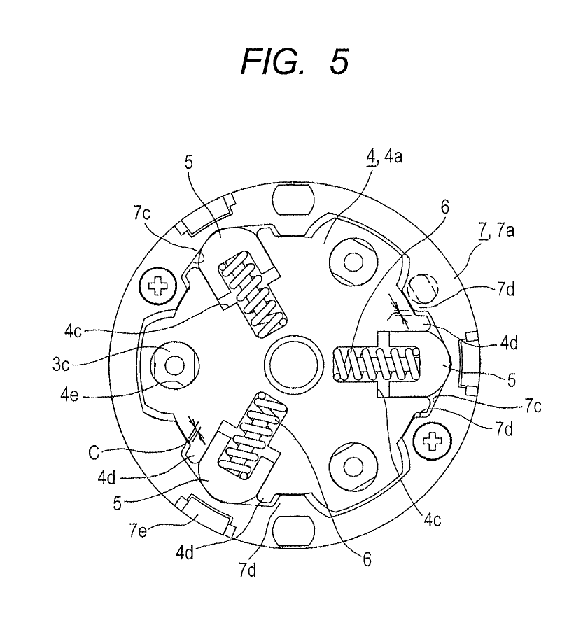

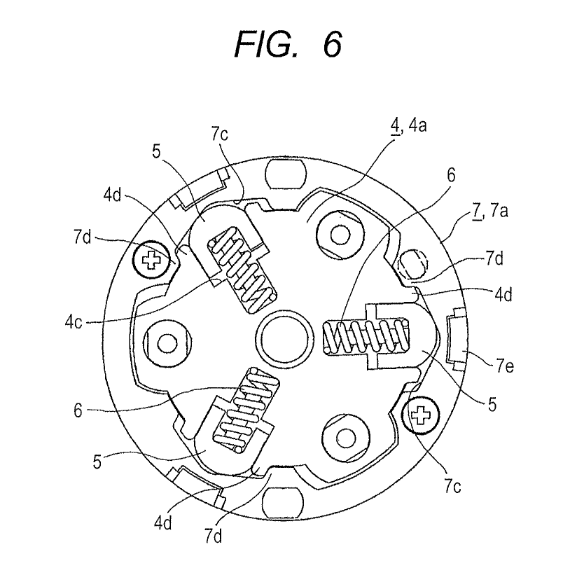

As shown in FIGS. 5 and 6, the first rotating body 4 is a resin molding that includes a plate-like portion 4a including recesses 4c opened to the outside in the radial direction, a columnar shaft portion 4b protruding downward from the central portion of the plate-like portion 4a in the vertical direction, and a plurality of holes 4e. The columnar shaft portion 4b is inserted into a center hole 9e of the electromagnetic brake 9. The plate-like portion 4a is disposed within the second rotating body 7, which has a ring shape, in the radial direction, and the recesses 4c are formed at three portions that are positioned on the plate-like portion 4a at regular intervals. The driving body 5 and the compression coil spring 6 are received in each of the recesses 4c, and the driving body 5 is held in the recess 4c so as to be capable of reciprocating. The compression coil spring 6 elastically energizes the driving body 5 toward a cam surface 7c, which will be described below, of the second rotating body 7 at all times, and the driving body 5 elastically comes into press contact with the cam surface 7c by the energizing force. Further, a plurality of stopper portions 4d are formed on the outer peripheral portion of the plate-like portion 4a so that an opening of each recess 4c is interposed between the stopper portions 4d. These stopper portions 4d have a shape where portions of the stopper portions 4d adjacent to the opening of the recess 4c protrude toward the cam surface 7c of the second rotating body 7.

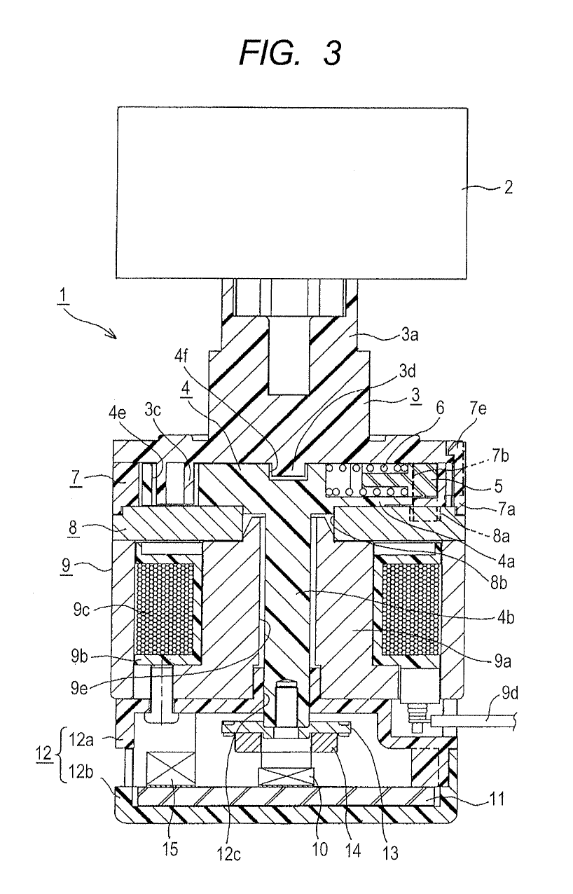

As shown in FIG. 3, the axis of the columnar shaft portion 4b of the first rotating body 4 corresponds to the rotational axis of the operating knob 2 and the columnar shaft portion 4b reaches the inside of the housing 12 through the center hole 9e of the electromagnetic brake 9. A back yoke 13 and an annular magnet 14 are fixed to the end portion of the columnar shaft portion 4b by a screw or the like, and a magnetic sensor 10 such as a GMR sensor is installed in the housing 12 at a position facing the annular magnet 14. Accordingly, when the operating knob 2 is rotated, the rotation angle and the rotation direction of the operating knob 2 are detected by the magnetic sensor 10.

The second rotating body 7 is a resin molding that is formed of a ring-shaped portion 7a having a ring-shaped appearance, and a connecting protrusion 7b protrudes from the ring-shaped portion 7a toward the friction plate 8. Further, cam surfaces 7c are formed at three portions that are positioned on the inner peripheral surface of the ring-shaped portion 7a at regular intervals in the circumferential direction, and these cam surfaces 7c are formed in a V shape in plan view so that the middle portion of the cam surface forms a valley portion and inclined surfaces extend from the valley portion in the rotation direction. Usually, the driving body 5 comes into press contact with the valley portion of each cam surface 7c as shown in FIG. 5, so that the movement of the driving body 5 along the cam surface 7c is restricted. Accordingly, the second rotating body 7 is rotated integrally and coaxially with the first rotating body 4 by the respective driving bodies 5. Furthermore, a plurality of restricting wall portions 7d are formed on the inner peripheral surface of the ring-shaped portion 7a so that each cam surface 7c is interposed between the restricting wall portions 7d, and these restricting wall portions 7d are formed at the portions adjacent to the inclined surfaces of the cam surfaces 7c so as to protrude inward in the radial direction. Moreover, each restricting wall portion 7d and each stopper portion 4d of the plate-like portion 4a face each other with a predetermined clearance C (see FIG. 5) in the rotation direction. Accordingly, even though the rotation of the second rotating body 7 is prevented, the first rotating body 4 can be rotated relative to the second rotating body 7 by the clearance C and the driving bodies 5 slide on the inclined surfaces of the cam surfaces 7c while increasing contact pressure with this relative rotation.

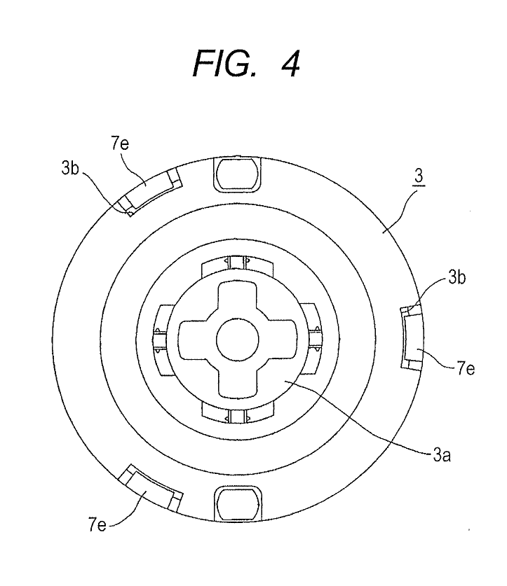

Further, the engaging pieces 7e protrude toward the knob connecting member 3 from three portions that are positioned on the outer peripheral portion of the ring-shaped portion 7a at regular intervals in the circumferential direction. Hook-shaped portions formed at the ends of the respective engaging pieces 7e are caught by the notches 3b of the knob connecting member 3. However, since the width of the notch 3b in the rotation direction is set to be larger than the width of the hook-shaped portion of the engaging piece 7e as shown in FIG. 4, the relative rotation of the knob connecting member 3 relative to the second rotating body 7 is allowed to some extent.

Since the connecting protrusion 7b of the second rotating body 7 is inserted into a connecting hole 8a of the friction plate 8 as shown in FIG. 3, the second rotating body 7 and the friction plate 8 are rotated integrally and coaxially. For this reason, when the friction plate 8 is magnetically attracted to the electromagnetic brake 9 so that the rotation of the friction plate 8 is prevented, the rotation of the second rotating body 7 is also prevented. Accordingly, if the operating knob 2 is rotated in this state, a braking force of the electromagnetic brake 9 is transmitted to the first rotating body 4 from the second rotating body 7.

The friction plate 8 is made of a soft magnetic material such as electromagnetic stainless steel, and is formed in the shape of a disc including a center hole 8b through which the columnar shaft portion 4b of the first rotating body 4 passes. Since the connecting hole 8a, which is engaged with the connecting protrusion 7b of the second rotating body 7, is formed in the friction plate 8 as described above, the friction plate 8 and the second rotating body 7 are rotated integrally. However, the movement of the friction plate 8 in the thrust direction is permitted relative to the second rotating body 7.

The electromagnetic brake 9 includes a cylindrical yoke core 9a that includes a center hole 9e and double walls, that is, inner and outer walls; a bobbin 9b that is received in the yoke core 9a; and a coil (solenoid) 9c that is wound on the bobbin 9b in a cylindrical shape. Both ends of the coil 9c are connected to a lead wire 9d. When current is applied to the coil 9c through the lead wire 9d, a magnetic force is generated and the friction plate 8 is attracted to the end face of the yoke core 9a by this magnetic force. That is, it is possible to make the friction plate 8 be magnetically attracted to the end face of the yoke core 9a while maintaining the engagement with the connecting protrusion 7b. Further, when a rotational driving force is applied to the second rotating body 7 from the first rotating body 4 while the friction plate 8 is magnetically attracted to the electromagnetic brake 9, a frictional force is generated between the end face of the yoke core 9a and the friction plate 8. Accordingly, this frictional force is applied to the first rotating body 4 as a braking force.

It is possible to control the intensity of the braking force, which is applied by the electromagnetic brake 9, according to the amount of current applied to the coil 9c. For example, it is possible to make a user feel that an operating force is slightly increased, by generating a small braking force (frictional force) during a rotating operation. However, the electromagnetic brake 9 is kept in a state where current is not applied in this embodiment as long as the operating knob 2 is not rotated up to both ends (hereinafter, a case of an end point will be described.) of the rotating operation range. Accordingly, the electromagnetic brake 9 does not apply a braking force. Further, when the operating knob 2 is rotated up to the end point of the rotating operation range, the electromagnetic brake 9 generates a strong braking force for preventing the rotation of the friction plate 8 so that a sensation of resistance, which is similar to a sensation when fingers bump against a wall, is given to user's fingers. Accordingly, it is possible to make a user perceive that the rotational position of the operating knob 2 reaches the end point of the rotating operation range, by an operation sensation.

The housing 12 is a substantially cylindrical box-shaped body that is formed by combining upper and lower cases 12a and 12b made of a resin. A center hole 12c into which the end portion of the columnar shaft portion 4b of the first rotating body 4 is inserted is formed in the upper case 12a. The back yoke 13 and the annular magnet 14 that are fixed to the end portion of the columnar shaft portion 4b, the circuit substrate 11 that is placed in and fixed to the lower case 12b, and the magnetic sensor 10 and a connector 15 that are mounted on the circuit substrate 11 are received in the housing 12. Since the back yoke 13 and the annular magnet 14 are integrally rotated with the rotation of the operating knob 2 as described above, the rotation angle and the rotation direction of the operating knob 2 are detected by the magnetic sensor 10. Moreover, a signal, which is detected by the magnetic sensor 10, is output to an external circuit (a control circuit or a power supply circuit) (not shown) through the connector 15. The back yoke 13, the annular magnet 14, and the magnetic sensor 10 form the detection means.

Next, the operation of the operation sensation imparting input device 1, which has the above-mentioned structure, at the time of the rotation of the operation sensation imparting input device 1 will be described. Since current is not applied to the electromagnetic brake 9 when a user rotates the operating knob 2 within a prescribed rotating operation range, the second rotating body 7 and the friction plate 8 are driven by the first rotating body 4 that is rotated integrally with the operating knob 2. Accordingly, the second rotating body 7 and the friction plate 8 are also rotated integrally with the operating knob 2. At this time, the driving bodies 5 held by the first rotating body 4 come into press contact with the valley portions of the cam surfaces 7c of the second rotating body 7 as shown in FIG. 5.

Further, when the user rotates the operating knob 2 up to the end point of the rotating operation range, the external circuit applies a predetermined current to the electromagnetic brake 9 on the basis of an output signal of the magnetic sensor 10 that detects the rotation of the operating knob 2 up to the end point of the rotating operation range. Accordingly, since the friction plate 8 is magnetically attracted to the end face of the yoke core 9a and the rotation of the friction plate 8 is prevented, the rotation of the second rotating body 7 is also prevented. As a result, a braking force is applied to the operating knob 2 and the first rotating body 4, so that a sensation of resistance, which is similar to a sensation when fingers bump against a wall, is given to user's fingers that are rotating the operating knob 2. At this time, the user can perceive that the rotational position of the operating knob 2 reaches the end point of the rotating operation range, but the operating knob 2 is rotationally driven up to the rotational position, which is slightly beyond the end point, by the inertia of an operating force.

That is, even though the operating knob 2 is rotated up to the end point of the rotating operation range and the rotation of the friction plate 8 and the second rotating body 7 is prevented by the braking of the electromagnetic brake 9, an operating force, which is applied to the operating knob 2 by a user, is not instantly removed and the operating force is actually applied to the operating knob 2 as it is due to an inertial force. Accordingly, since the first rotating body 4 starts to be rotated relative to the second rotating body 7 and the driving bodies 5 are separated from the valley portions of the cam surfaces 7c and slide on the inclined surfaces, the compression coil springs 6 energizing the driving bodies 5 are gradually compressed and the contact pressure between the driving bodies 5 and the cam surfaces 7c is increased by the reaction forces of the compression coil springs 6. For this reason, when the operating knob 2 is rotated beyond the end point of the rotating operation range, a sensation of resistance is given to the user's fingers operating the operating knob 2 so as to be gradually increased. Moreover, when the stopper portions 4d of the first rotating body 4 come into contact with the restricting wall portions 7d of the second rotating body 7 as shown in FIG. 6, the first rotating body 4 is not rotated relative to the second rotating body 7 any more. At this time, the first rotating body 4 can be rotated relative to the second rotating body 7 by the clearance C that is an interval between the stopper portion 4d and the restricting wall portion 7d. In this embodiment, the rotation angle corresponding to the clearance C is set to about 1°.

Further, since the magnetic sensor 10 detects the reversal of the rotation direction when the operating knob 2 having been rotated beyond the end point of the rotating operation range is rotated in a reverse direction, the external circuit cuts off current, which is applied to the electromagnetic brake 9, on the basis of the output signal of the magnetic sensor 10. Accordingly, the braking of the electromagnetic brake 9 is released and the friction plate 8 and the second rotating body 7 return to a rotatable state, so that the user can perform an operation for returning the operating knob 2 into the rotating operation range without any trouble.

Since the driving bodies 5 elastically come into press contact with the cam surfaces 7c in the operation sensation imparting input device 1 according to this embodiment as described above, it is possible to integrally rotate the first and second rotating bodies 4 and 7 while the friction plate 8 is not magnetically attracted to the electromagnetic brake 9. Moreover, since it is possible to transmit a braking force to the first rotating body 4 through the second rotating body 7 by applying a current to the electromagnetic brake 9 to prevent the rotation of the friction plate 8 when the operating knob 2 is rotated to the end point of the rotating operation range, it is possible to give a sensation of resistance to a user that is rotating the operating knob 2. Since this sensation of resistance is a sensation of resistance that is generated when the driving bodies 5 slide on the cam surfaces 7c while increasing the contact pressure with the relative rotation of the first rotating body 4 relative to the second rotating body 7, it is easy to accurately set the intensity of the sensation of resistance. Further, when the first rotating body 4 is rotated relative to the second rotating body 7 by a predetermined angle, a part of the rotating body 4 comes into contact with a part of the rotating body 7, so that the first rotating body 4 is not rotated relative to the second rotating body 7 any more. Accordingly, it is also easy to accurately set an allowable rotation angle of the operating knob 2. That is, since the operation sensation imparting input device 1 includes a simple mechanism that can accurately set an allowable rotation angle and the intensity of a sensation of resistance at the time of rotation, it is easy to realize an intended operation sensation or operability and it is also possible to expect an increase in life and a reduction in cost. In addition, since the operation sensation imparting input device 1 has a structure where the first rotating body 4 is disposed within the ring-shaped portion 7a of the second rotating body 7 in the radial direction, it is possible to reduce the size of the operation sensation imparting input device 1 in the thrust direction. Accordingly, it is easy to reduce the thickness of the operation sensation imparting input device 1.

Further, in the operation sensation imparting input device 1 according to this embodiment, the driving bodies 5, which come into press contact with the cam surfaces 7c of the second rotating body 7, and the compression coil springs 6, which elastically energize the driving bodies 5 toward the cam surfaces 7c, are received in the recesses 4c of the first rotating body 4 and the first rotating body 4 is rotated relative to the second rotating body 7 while the driving bodies 5 slide on the cam surfaces 7c. For this reason, it is possible to easily realize a simple mechanism that allows the further rotation of the operating knob 2 to which a braking force has been applied and the reliability of the operation of the simple mechanism is also high. Furthermore, since the driving bodies 5 elastically come into press contact with the cam surfaces 7c due to the energizing forces of the compression coil springs 6, it is possible to make the driving bodies 5 come into elastic contact with the cam surfaces 7c with necessary and sufficient contact pressure and it is easy to improve durability. However, it may be possible to elastically energize the driving bodies 5 by using spring members such as torsion coil springs other than the compression coil springs.

Moreover, in the operation sensation imparting input device 1 according to this embodiment, the second rotating body 7 includes the restricting wall portions 7d near the cam surfaces 7c and the first rotating body 4 includes the stopper portions 4d near the recesses 4c. Further, since the restricting wall portions 7d and the stopper portions 4d face each other with predetermined clearances C in the rotation direction while the friction plate 8 is magnetically attracted to the electromagnetic brake 9, the relative rotation of the first rotating body 4 relative to the second rotating body 7 is allowed by the clearance C when the rotation of the friction plate 8 is prevented. For this reason, it is possible to easily realize a simple mechanism that can accurately set the allowable rotation angle of the operating knob 2 and the reliability of the operation of the simple mechanism is also high.

Meanwhile, the driving bodies 5 have been elastically energized by spring members (compression coil springs 6) in the above-mentioned embodiment. However, if driving bodies made of an elastic material such as silicon rubber, which is rich in durability, are used, the spring members such as the compression coil springs may be omitted. Moreover, in contrast to the above-mentioned embodiment, cam surfaces may be formed on the first rotating body 4 and the second rotating body 7 may hold driving bodies. In addition, three driving bodies have come into elastic contact with the corresponding cam surfaces in the above-mentioned embodiment, but the number of driving bodies to be used may not be three (for example, two or four).

Further, in the above-mentioned embodiment, a magnet, a magnetic sensor, and the like have been used as detection means for detecting the rotational position of the operating knob 2. However, it may be possible to detect the rotational position of the operating knob 2 by using other detection means such as an optical sensor.

It should be understood by those skilled in the art that various modifications, combinations, sub-combinations and alterations may occur depending on design requirements and other factors insofar as they are within the scope of the appended claims of the equivalents thereof.

What is claimed is:

1. An operation sensation imparting input device comprising:
a rotatable operating knob;
a first rotating body that is driven by the operating knob and is rotated coaxially with the operating knob;
a second rotating body that is driven by the first rotating body, is rotatable coaxially with first rotating body, and transmits a braking force to the first rotating body;
a friction plate that is rotated integrally with the second rotating body;
an electromagnetic brake that applies a braking force by magnetically attracting the friction plate when current is applied to the electromagnetic brake; and
a detection mechanism that detects the rotational position of the operating knob,
wherein cam surfaces are formed on one of the first and second rotating bodies, and driving bodies elastically coming into press contact with the cam surfaces are held by the other thereof,
while the rotation of the friction plate is prevented by the magnetic attraction of the electromagnetic brake, the first rotating body is rotatable relative to the second rotating body until the first rotating body comes into contact with the second rotating body so that the position of the first rotating body is restricted, and
the driving bodies slide on the cam surfaces while increasing contact pressure with the relative rotation.

2. The operation sensation imparting input device according to claim 1,
wherein the second rotating body includes a ring-shaped portion and the first rotating body is disposed within the ring-shaped portion in a radial direction.

3. The operation sensation imparting input device according to claim 2,
wherein the first rotating body includes recesses opened to the outside in the radial direction, the driving bodies are received in the recesses so as to protrude and retract, and the cam surfaces are formed on the inner peripheral surface of the ring-shaped portion.

4. The operation sensation imparting input device according to claim 3,
wherein spring members, which elastically energize the driving bodies toward the cam surfaces, are received in the recesses of the first rotating body.

5. The operation sensation imparting input device according to claim 3,
wherein the ring-shaped portion includes restricting wall portions near the cam surfaces,
the first rotating body includes stopper portions, which come into contact with the restricting wall portions, near the recess, and
the restricting wall portions and the stopper portions face each other with predetermined clearances in a rotation direction while the friction plate is not magnetically attracted to the electromagnetic brake, so that relative rotation, when the rotation of the friction plate is prevented, is allowed by the clearance.

6. The operation sensation imparting input device according to claim 4,
wherein the ring-shaped portion includes restricting wall portions near the cam surfaces,
the first rotating body includes stopper portions, which come into contact with the restricting wall portions, near the recess, and
the restricting wall portions and the stopper portions face each other with predetermined clearances in a rotation direction while the friction plate is not magnetically attracted to the electromagnetic brake, so that relative rotation, when the rotation of the friction plate is prevented, is allowed by the clearance.
